(19) United States
(12) Patent Application Publication
(10) Pub. No.: US 2025/0120549 A1
(43) Pub. Date: Apr. 17, 2025

(54) BRUSHLESS MOTOR MOUNTING STRUCTURE OF MILK-SHAKING SEAT AND MILK SHAKER WITH THE SAME

(71) Applicant: Aiguang Chen, Yongjia (CN)

(72) Inventor: Aiguang Chen, Yongjia (CN)

(21) Appl. No.: 18/991,350

(22) Filed: Dec. 21, 2024

(30) Foreign Application Priority Data
Nov. 22, 2024 (CN) 202422864463.4

(51) Int. Cl. A47J 43/08; A47J 43/042; H02K 1/18

(52) U.S. Cl. CPC A47J 43/08; A47J 43/042; H02K 1/18

(57) ABSTRACT

The present disclosure discloses a brushless motor mounting structure of a milk-shaking seat and a milk shaker having the same. The milk shaker seat comprises a milk bottle placement cavity and a motor mounting cavity, the brushless motor mounting structure includes a motor and a motor base. The motor comprise a steel sleeve, a magnetic ring, and a motor stator; the steel sleeve is embedded in the inner wall of the motor mounting cavity; the magnetic ring is sleeved inside the steel sleeve, and the magnetic ring, the steel sleeve, and milk-shaking seat form the rotor of the motor; the motor stator is sleeved in the inner cavity of the magnetic ring, and its outer wall rotatably abutting against the inner wall of the magnetic ring; the motor base is sleeved at the bottom of the milk-shaking seat.

### TECHNICAL FIELD

The present disclosure relates to the technical field of maternal and infant products, more specifically, to a brushless motor mounting structure of a milk-shaking seat and a milk shaker having the same.

### BACKGROUND ART

During the infant and toddler stages, people usually choose milk powder to feed infants and toddlers to ensure healthy growth thereof. However, a lot of milk powder dissolves slowly and require a long time of manual shaking to enable full dissolution of the milk powder into water, so that the operation is very troublesome. To facilitate the shaking of the milk bottle and ensure that the milk powder is fully dissolved, people opt to use a milk shaker.

Currently, the motors of commonly-used milk shakers are mostly mounted on the milk-shaking seat through a secondary mountingmounting structure. During long-term use, the motor tends to become loose, resulting in an unstable motor mounting. Moreover, this secondary mountingmounting structure affects the mounting mounting precision of the motor, thereby leading to increased noise and ultimately reducing the lifespan of the milk shaker.

Therefore, it is a problem to be urgently addressed by those skilled in the art to provide a brushless motor mounting mounting structure of a milk-shaking seat with high mounting precision, low noise, and long service life, as well as a milk shaker having the same.

### SUMMARY

In view of this, the present disclosure provides a brushless motor mounting structure of a milk-shaking seat and a milk shaker having the same, aiming to solve the above technical problems.

To achieve the above objective, the present disclosure adopts the following technical solutions:

A brushless motor mounting structure of a milk-shaking seat, said structure being disposed on a milk-shaking seat, an inner cavity of the milk-shaking seat being partitioned by a partition plate into a milk bottle placement cavity and a motor mounting cavity from top to bottom, the brushless motor mounting structure comprising a motor and a motor base,
the motor comprises a steel sleeve, a magnetic ring, and a motor stator; the steel sleeve is embedded in an inner wall of the milk-shaking seat facing the motor mounting cavity; the magnetic ring is sleeved in an inner cavity of the steel sleeve, and has an outer wall fixed to an inner wall of the steel sleeve, and the magnetic ring, the steel sleeve, and the milk-shaking seat together form a rotor of the motor; the motor stator is sleeved in an inner cavity of the magnetic ring, with its outer wall rotatably abutting against the inner wall of the magnetic ring;
the motor base is sleeved in the bottom of the milk-shaking seat, a protruding support is fixed at the bottom of the motor base, and the protrusion of the support is embedded in an annular cavity of the motor stator.

Advantageous effects of the above technical solution is as follows: the motor rotor and the milk-shaking seat are fixed to form a whole, the motor rotor is fixed with the support on the motor base, the milk-shaking seat may, on the one hand may be used for placing a milk bottle, and on the other hand, may be used as a rotor of the motor, and has advantages such as better firmness and stability and larger strength as compared with the secondary mounting in the prior art; tolerance precision is also effectively controlled, and the precision level is comprehensively improved.

Preferably, the bottom of the milk-shaking seat is inserted into the inner cavity of the motor base, there is a rotational gap between the outer wall of the milk-shaking seat and the inner wall of the motor base, and the bottom wall of the milk-shaking seat rotatably abuts against the bottom wall of the motor base. It is ensured that the milk-shaking seat can rotate relative to the motor base, and meanwhile the milk bottle can be placed on the milk-shaking seat.

Preferably, the support is a zinc alloy support. The structural strength between the motor base and the motor rotor is improved.

Preferably, a through hole provided on the support is communicated with a through hole provided on the partition plate, a rotation shaft is rotatably connected within the through holes of the support and the partition plate, and an top end of the rotation shaft is fixed to the partition plate 14 relative to an inner wall of through hole of the partition plate. The motor drives the rotation shaft to rotate, the rotation shaft brings the milk-shaking seat into rotation during rotation, and the shaking of the milk bottle is achieved through the rotation of the milk-shaking seat.

Preferably, a copper sleeve is sleeved around the rotation shaft, and an outer wall of the copper sleeve is embedded with the inner wall of the through hole of the partition plate and the inner wall of the through hole of the support. The structural strength and service lifespan between the milk-shaking seat and the rotation shaft are improved.

Preferably, a plurality of annular grooves are circumferentially provided on the outer wall of the steel sleeve, a plurality of annular projections matching these grooves are fixed on the inner wall of the milk-shaking seat facing the motor mounting cavity, and the steel sleeve is embedded on the projections through the grooves. The mounting precision and structural strength of the rotation shaft may be improved in the convex-concave embedding manner.

Preferably, the steel sleeve and the milk-shaking seat are integrally fabricated and formed. The integral fabrication and forming avoids the secondary mounting between the steel sleeve and the milk-shaking seat so that the motor mounting structure runs more stably and the strength is improved, and the tolerance precision can be effectively controlled.

Preferably, an electromagnetic coil is fixed on an inner wall of the top end of the motor base.

The present disclosure further provides a milk shaker employing the brushless motor mounting structure of the milk-shaking seat. The milk shaker further comprises a housing which is sleeved and fixed around an outer circumference of the milk-shaking seat and motor base, and a placement hole corresponding to the milk bottle placement cavity is provided at the top of the housing. The whole mounting structure formed by the milk-shaking seat and the motor base is embedded in the housing, the milk bottle is placed in the milk bottle placement cavity of the milk-shaking seat, and the shaking of the milk bottle is achieved by the rotation of the milk-shaking seat relative to the motor base.

Preferably, clamping claws are fixed on the inner wall of the top end of the milk-shaking seat to clamp the milk bottle. The clamping claws can hold the milk bottle in the milk bottle placement cavity, and the stability during the shaking of the milk bottle is improved through the clamping claws.

As known from the above technical solutions, as compared with the prior art, the present disclosure provides a brushless motor mounting structure of a milk-shaking seat and a milk shaker having the same; the motor rotor and the milk-shaking seat are integrally formed, and the motor stator is fixed with the support in the motor base. The milk-shaking seat serves as the rotor of the motor. By integrating the milk-shaking seat and motor rotor into one piece, the present disclosure offers more firm stability and greater strength than the secondary mounting in the prior art. Tolerance accuracy is effectively controlled, and precision levels are comprehensively improved. This structure allows for reduced swinging and vibration of the milk-shaking seat and the milk bottle placed on it, effectively reducing noise during operation and extending machine lifetime.

### BRIEF DESCRIPTION OF THE DRAWINGS

To more clearly illustrate the technical solutions in embodiments of the present disclosure or the prior art, a brief introduction to the drawings needed for describing the embodiments or the prior art will be provided below. It is evident that the drawings described herein are merely examples of the embodiments of the present disclosure, and those skilled in the art can obtain other drawings according to the provided drawings without making inventive efforts.

FIG. 1 is a bottom view of a milk-shaking seat provided by the present disclosure;

FIG. 2 is an exploded view of a milk-shaking seat provided by the present disclosure;

FIG. 3 is a cross-sectional view of a milk-shaking seat provided by the present disclosure;

FIG. 4 is a structural diagram of a milk shaker provided by the present disclosure;

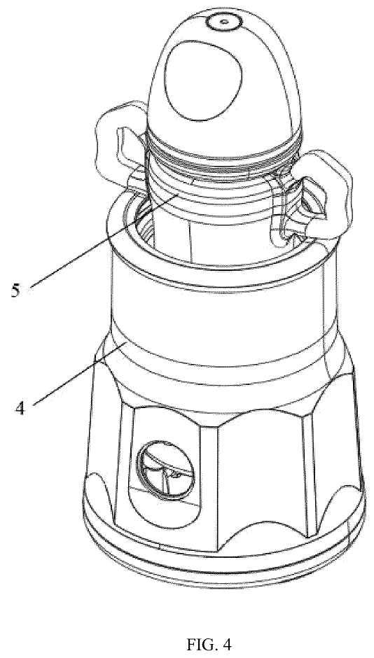

FIG. 5 is a cross-sectional view of a milk shaker provided by the present disclosure.

Wherein:
1—Milk-shaking seat; 11—Clamping claw; 12—Milk bottle placement cavity; 13—Motor mounting cavity; 14—Partition plate; 15—Reinforcement plate;
2—Motor; 21—Steel sleeve; 22—Magnetic ring; 23—Motor stator; 24—Groove;
3—Motor base; 31—Electromagnetic coil; 32—Support;
4—Housing;
5—Milk bottle;
6—Shaft;
7—Copper sleeve.

### DETAILED DESCRIPTION OF THE EMBODIMENTS

Technical solutions in embodiments of the present disclosure will be clearly and completely described below in conjunction with figures in embodiments of the present disclosure. Obviously, embodiments described herein are only partial embodiments rather than all embodiments of the present disclosure. the present disclosureBased on the embodiments of the present disclosure, all other embodiments obtained by those skilled in the art without exerting creative labor fall within the scope of protection of the present disclosure.

### Embodiment 1

This embodiment of the present disclosure discloses a brushless motor mountingstructure of a milk-shaking seat, said structure being disposed on a milk-shaking seat 1. An inner cavity of the milk-shaking seat 1 is partitioned by a partition plate 14 into a milk bottle placement cavity 12 and a motor mounting cavity 13 from top to bottom. The brushless motor mounting structure includes a motor 2 and a motor base 3,

The motor 2 comprises a steel sleeve 21, a magnetic ring 22, and a motor stator 23; the steel sleeve 21 is embedded in an inner wall of the milk-shaking seat 1 facing the motor mounting cavity 13; the magnetic ring 22 is sleeved in an inner cavity of the steel sleeve 21, and has an outer wall fixed to an inner wall of the steel sleeve 21, and the magnetic ring 22, the steel sleeve 21, and the milk-shaking seat 1 together form a rotor of the motor 2; the motor stator 23 is sleeved in an inner cavity of the magnetic ring 22, with its outer wall rotatably abutting against the inner wall of the magnetic ring 22;

The motor base 3 is sleeved in the bottom of the milk-shaking seat 1, a protruding support 32 is fixed at a bottom of the motor base 3, and the protrusion of the support 32 is embedded in an annular cavity of the motor stator 23.

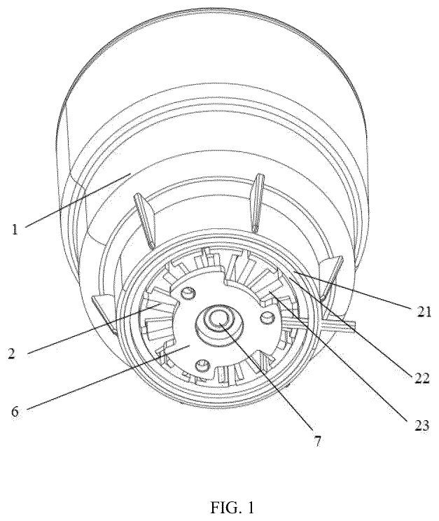

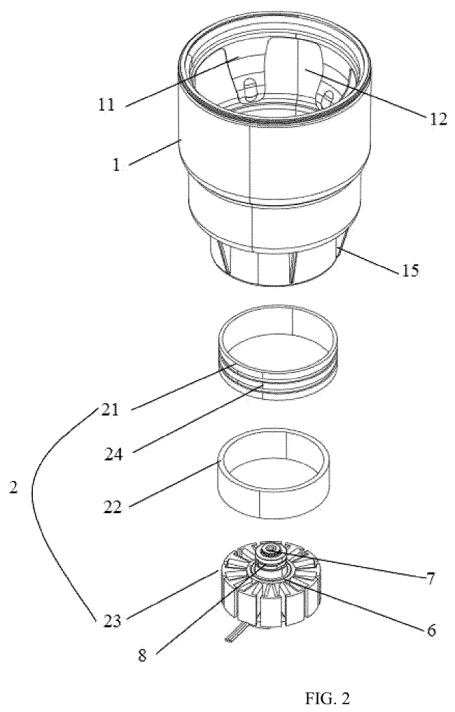

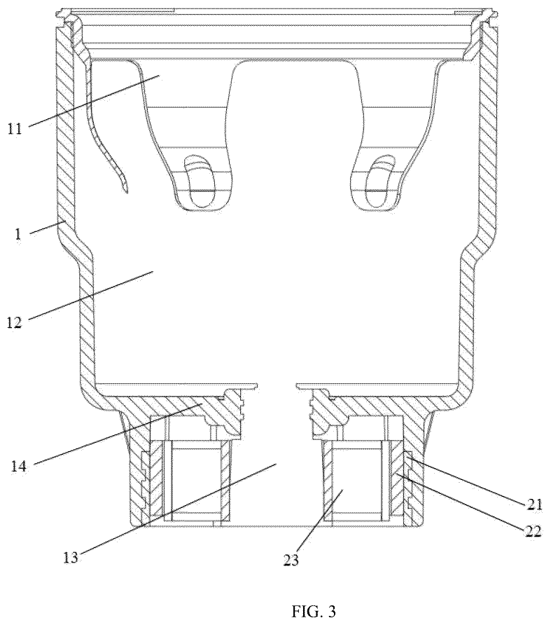

As shown in FIGS. 1-3 and 5, the milk-shaking seat is a cylindrical structure with an upper inner diameter larger than a lower inner diameter. An upper cylindrical body is used for placing the milk bottle, and a lower cylindrical body is used for mounting the motor. The steel sleeve is fixed to the milk-shaking seat, the magnetic ring is sleeved in the steel sleeve, and the motor stator is sleeved in the magnetic ring. The motor stator is fixed ins the magnetic ring through the support in the motor base. In this manner, the whole structure formed by the milk-shaking seat, steel sleeve, and magnetic ring serves as the rotor of the motor. While serving as the motor's rotor, the milk-shaking seat also fulfills the function of placing the milk bottle, and offers more secure stability and greater strength as compared with the secondary mounting structure in the prior art. Tolerance precision is effectively controlled, and the precision level is comprehensively improved.

To further optimize the above technical solution, to better achieve rotation of the milk-shaking seat, the bottom of the milk-shaking seat 1 is inserted into the inner cavity of the motor base 3, there is a rotational gap between the outer wall of the milk-shaking seat 1 and the inner wall of the motor base 3, and the bottom wall of the milk-shaking seat 1 rotatably abuts against the bottom wall of the motor base 3.

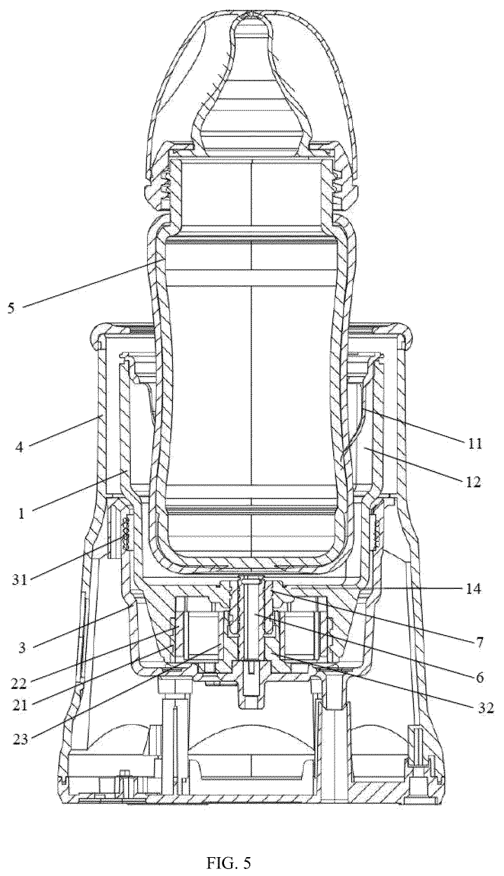

As shown in FIG. 5, the motor base is also a cylindrical structure. An inner diameter of an upper part of the milk bottle placement cavity of the milk-shaking seat is larger than that of a lower part of the milk bottle placement cavity, and the inner diameter of the lower part of the milk bottle placement cavity is larger than that of the motor mounting cavity. A portion of the milk-shaking seat corresponding to the lower part of the milk bottle placement cavity and the motor mounting cavity is inserted into the inner cavity of the motor base, thereby ensuring effective rotation of the milk-shaking seat within the motor base.

To further optimize the above technical solution, to improve the length of the milk-shaking seat make it have an enough service lifespan during long-term use, a plurality of reinforcing plates 15 are fixed to the outer wall of the milk-shaking seat 1 opposite to its motor mounting cavity 13.

To further optimize the above technical solution and ensure the mounting strength of the motor, the support 32 is made of a zinc alloy. A round protruding structure on top of the support is inserted into the annular cavity of the motor stator and is fixed to the inner wall of the motor stator, thereby ensuring that the bottom wall of the milk-shaking seat rotatably abuts against the bottom wall of the motor base.

In the present embodiment, a through hole provided on the support 32 is communicated with a through hole provided on the partition plate 14, a rotation shaft 6 is rotatably connected within the through holes of the support 32 and the partition plate 14, and an top end of the rotation shaft 6 is fixed to the partition plate 14 relative to an inner wall of the through hole of the partition plate 14.

The rotation of the milk-shaking seat is achieved through the rotation shaft. In the present embodiment, the motor is a brushless motor, the rotor of the rotor is a permanent magnet magnetic ring steel sleeve and is together with the milk-shaking seat, connected with the rotation shaft. The motor stator is a winding coil, omitting commutating brushes used by a brushed motor to alternatingly commutating the electromagnetic field. The motor comprises a permanent magnet rotor, a multi-pole winding stator, a position sensor, etc. The position sensor commutates the current in the stator winding in a certain order according to changes in the rotor position (i.e., detecting the position of the rotor's magnetic poles relative to the stator winding, generating position sensing signals at determined positions, controlling a power switch circuit after the position sensing signals are processed by a conversion circuit, to commutate the winding current according to a certain logic relationship). The working voltage of the stator windings is provided by an electronic switch circuit controlled by the position sensor output. A semiconductor switching device is employed to achieve electronic commutation, i.e., the electronic switch device is used to replace the traditional contact-type commutators and brushes.

To further optimize the above technical solution and enhance the stability of the rotation shaft and the strength of the motor mounting structure, a copper sleeve 7 is sleeved around the rotation shaft 6, and an outer wall of the copper sleeve 7 is embedded with the inner wall of the through hole of the partition plate 14 and the inner wall of the through hole of the support 32.

As shown in FIG. 5, a plurality of annular grooves are axially provided on the outer wall of the copper sleeve, a plurality of annular protrusions are fixed on the inner wall of the through hole of the partition plate and the inner wall of the through hole of the support, respectively, and the sleeve is fixed in a way that the annular protrusions are embedded in the annular grooves.

To further optimize the above technical solution and improve the tolerance precision and stability of the steel sleeve, a plurality of annular grooves 24 are circumferentially provided on the outer wall of the steel sleeve 21, a plurality of annular projections matching these grooves are fixed on the inner wall of the milk-shaking seat 1 facing the motor mounting cavity 13. The steel sleeve 21 is embedded on the projections through the grooves 24.

In the present embodiment, the steel sleeve 21 and milk-shaking seat 1 are integrally fabricated and formed. The steel sleeve is directly placed into a mold or jig for secondary shaping with the milk-shaking seat, such that the steel sleeve is tightly enclosed within a hot melt plastic of the milk-shaking seat and completely, compactly enclosed and fixed after the forming and cooling of the mold.

### Embodiment 2

This embodiment of the present disclosure provides a milk shaker employing the brushless motor mounting structure of the milk-shaking seat described in Embodiment 1. The milk shaker further comprises a housing 4. The housing 4 is sleeved and fixed around an outer circumference of the milk-shaking seat 1 and motor base 3, and a placement hole corresponding to the milk bottle placement cavity 12 is provided at the top of the housing 4.

To further optimize the above technical solution and ensure stability during shaking, clamping claws 11 are fixed on the inner wall of the top end of the milk-shaking seat 1 to clamp the milk bottle 5 securely.

The embodiments in the description are described in a progressive manner, and each embodiment focuses on the differences from other embodiments. The same and similar parts between the various embodiments can be referred to each other. For the device disclosed in the embodiment, since it corresponds to the method disclosed in the embodiments, it is described simply and refernce may be made to the depictions of the method for relevant parts.

The above description of the disclosed embodiments enables those skilled in the art to implement or use the present disclosure. Various modifications to these embodiments will be obvious to those skilled in the art, and the general principles defined in the text herein can be implemented in other embodiments without departing from the spirit or scope of the present disclosure. Therefore, the present disclosure will not be limited to the embodiments illustrated in the text herein, but will conform to the widest range consistent with the principles and novel features disclosed in the text herein.

What is claimed is:

1. A brushless motor mounting structure of a milk-shaking seat, said structure being disposed on a milk-shaking seat (1), an inner cavity of the milk-shaking seat (1) being partitioned by a partition plate (14) into a milk bottle placement cavity (12) and a motor mounting cavity (13) from top to bottom, wherein the brushless motor mounting structure comprising a motor (2) and a motor base (3),
the motor (2) comprises a steel sleeve (21), a magnetic ring (22), and an annular motor stator (23); the steel sleeve (21) is embedded in an inner wall of the milk-shaking seat (1) facing the motor mounting cavity (13); the magnetic ring (22) is sleeved in an inner cavity of the steel sleeve (21), and has an outer wall fixed to an inner wall of the steel sleeve (21), and the magnetic ring (22), the steel sleeve (21), and the milk-shaking seat (1) together form a rotor of the motor (2); the motor stator (23) is sleeved in an inner cavity of the magnetic ring (22), with its outer wall rotatably abutting against the inner wall of the magnetic ring (22);
the motor base (3) is sleeved in the bottom of the milk-shaking seat (1), a protruding support (32) is fixed at the bottom of the motor base (3), and the protrusion of the support (32) is embedded in an annular cavity of the motor stator (23).

2. The brushless motor mounting structure of a milk-shaking seat according to claim 1, wherein the bottom of the milk-shaking seat (1) is inserted into the inner cavity of the motor base (3), there is a rotational gap between the outer wall of the milk-shaking seat (1) and the inner wall of the motor base (3), and the bottom wall of the milk-shaking seat (1) rotatably abuts against the bottom wall of the motor base (3).

3. The brushless motor mounting structure of a milk-shaking seat according to claim 1, wherein the support (32) is a zinc alloy support.

4. The brushless motor mounting structure of a milk-shaking seat according to claim 1, wherein a through hole provided on the support (32) is communicated with a through hole provided on the partition plate (14), a rotation shaft (6) is rotatably connected within the through holes of the support (32) and the partition plate (14), and an top end of the rotation shaft (6) is fixed to the partition plate (14) relative to an inner wall of through hole of the partition plate (14).

5. The brushless motor mounting structure of a milk-shaking seat according to claim 4, wherein a copper sleeve (7) is sleeved around the rotation shaft (6), and an outer wall of the copper sleeve (7) is embedded with the inner wall of the through hole of the partition plate (14) and the inner wall of the through hole of the support (32).

6. The brushless motor mounting structure of a milk-shaking seat according to claim 1, wherein a plurality of annular grooves (24) are circumferentially provided on the outer wall of the steel sleeve (21), a plurality of annular projections matching these grooves are fixed on the inner wall of the milk-shaking seat (1) facing the motor mounting cavity (13), and the steel sleeve (21) is embedded on the projections through the grooves (24).

7. The brushless motor mounting structure of a milk-shaking seat according to claim 6, wherein the steel sleeve (21) and the milk-shaking seat (1) are integrally fabricated and formed.

8. The brushless motor mounting structure of a milk-shaking seat according to claim 1, wherein an electromagnetic coil (31) is fixed on an inner wall of the top end of the motor base (3).

9. A milk shaker employing the brushless motor mounting structure of the milk-shaking seat according to any of claims 1-8, wherein the milk shaker further comprises a housing (4) which is sleeved and fixed around an outer circumference of the milk-shaking seat (1) and motor base (3), and a placement hole corresponding to the milk bottle placement cavity (12) is provided at the top of the housing (4).

10. The milk shaker according to claim 9, wherein clamping claws (11) are fixed on the inner wall of the top end of the milk-shaking seat (1) to clamp the milk bottle.
